(19) United States
(12) Patent Application Publication
(10) Pub. No.: US 2026/0166461 A1
(43) Pub. Date: Jun. 18, 2026

(54) Pre-Treatment Dust Removal Filter Bag Dust Collecting Apparatus Based on Inertial Collision and Edge IOT, and Control Method Thereof

(71) Applicant: EMSOLUTION CO., Ltd., Suwon (KR)

(72) Inventors: Hoon Min PARK, Yongin (KR); Hyun Min JUNG, Hwaseong (KR); Dae Hee LEE, Seoul (KR); Dal Hwan YOON, Jecheon (KR)

(21) Appl. No.: 19/332,403

(22) Filed: Sep. 18, 2025

(30) Foreign Application Priority Data
Dec. 18, 2024 (KR) 10-2024-0189837

(51) Int. Cl. B01D 46/02; B01D 46/04

(52) U.S. Cl. CPC B01D 46/023; B01D 46/04

(57) ABSTRACT

A dust collecting apparatus using a filter bag and a control method thereof are disclosed. The dust collecting apparatus may include a housing having a funnel-shaped dust outlet; an internal partition installed vertically downward to divide the inner upper portion of the housing into two sides; a plurality of filter bags being installed at one side of the inner upper portion of the housing; a contaminated gas inlet for injecting a contaminated gas into the upper portion of the other side of the housing; and a gas outlet being installed at the upper portion of the plurality of filter bags and discharging a gas filtered by each of the filter bags. The internal partition primarily performs inertial collision on the contaminated gas being injected, and each of the filter bags secondarily performs filtering on the contaminated gas passing through the lower end of the internal partition.

### CROSS-REFERENCE TO RELATED APPLICATION

This present application claims priority to Korean Application No. 10-2024-0189837 filed on December 18, 2024, the entire contents of which are hereby expressly incorporated by reference into the present application.

### TECHNICAL FIELD

The present invention relates to a pre-treatment dust removal filter bag dust collecting apparatus based on inertial collision and edge IoT (Internet of Things) and a control method thereof, and more particularly, to a pre-treatment dust removal filter bag dust collecting apparatus based on inertial collision and edge IoT and a control method thereof, which improves the filtration efficiency of a filter bag even when contaminated air contains moisture or oil components and allows dust such as fine particles or dirt filtered by the filter bag to be smoothly discharged through an outlet.

### BACKGROUND ART

In general, dust collecting apparatus is used to purify the air and improve the working environment by capturing dust or other particles from contaminated air in various industrial sites such as thermal power plants that use pulverized coal or steel mills that generate a lot of dust.

The dust collecting apparatus used in this way forcibly sucks in contaminated air containing fine particles or dirt and passes it through a filter bag made of non-woven fabric, and the like, so that dust such as fine particles or dirt contained in the contaminated air is filtered by the filter bag, and only the filtered clean air is discharged to the outside.

In addition, the dust collecting apparatus causes dust such as fine particles or dirt filtered by the filter bag to fall downward by spraying compressed air in the opposite direction to the filter bag and is discharged through an outlet formed at a lower side of the dust collecting apparatus.

However, in the case of a general dust collecting apparatus, if the contaminated air contains moisture or oil, dust may stick to the surface of the filter bag due to the moisture or oil, and as a result, even if compressed air is blown in the opposite direction to the filter bag, the dust does not fall downward but remains, which reduces the filtration efficiency of the filter bag.

In addition, dust falling downward from the filter bag may clump together due to moisture or oil contained in the contaminated air, and as a result, dust cannot be discharged through the outlet of the dust collecting apparatus, but remains at the lower end of the dust collecting apparatus, which blocks the discharge of other dust and reduces the discharge performance of the dust collecting apparatus.

### DESCRIPTION OF THE INVENTION

### Technical Subject

The present invention has been created to solve the above-mentioned problem, and the purpose of the present invention is to provide a pre-treatment dust removal filter bag dust collecting apparatus and a control method thereof, which improves the filtration efficiency of a filter bag by removing dust at an internal partition using inertial collision even when contaminated air contains moisture or oil components, and allows dust such as fine particles or dirt filtered by the filter bag to be smoothly discharged through an outlet.

### Technical Solution

In order to achieve the above-described object, a pre-treatment dust removal filter bag dust collecting apparatus using inertial collision according to one aspect of the present invention is characterized in that comprising: a housing having a funnel-shaped dust outlet formed at a cylindrical lower end; an internal partition installed vertically downward from an upper surface of the housing to divide the inner upper portion of the housing into two sides; a plurality of filter bags being installed at one side of the inner upper portion of the housing with reference to the internal partition; a contaminated gas inlet for injecting a contaminated gas into the upper portion of the other side of the housing with reference to the internal partition; and a gas outlet being installed at the upper portion of the plurality of filter bags and discharging a gas filtered by each of the filter bags, wherein the internal partition primarily performs inertial collision on the contaminated gas being injected, and wherein each of the filter bags secondarily performs filtering on the contaminated gas passing through the lower end of the internal partition.

The aforementioned dust collecting apparatus may further include an air injector that injects air toward each of the filter bags at the lower end of the housing.

The aforementioned dust collecting apparatus may further include: a humidity measurement sensor that measures humidity of contaminated gas at the lower end of the internal partition; and an air regulator for controlling at least one of the temperature and injection strength of air injected through the air injector according to the measured humidity.

The aforementioned dust collecting apparatus may further include a vibration application unit that applies vibration to a funnel-shaped inclined surface of the housing.

The aforementioned dust collecting apparatus may further include: a weight measurement sensor that measures a weight applied to a funnel-shaped inclined surface of the housing; and a vibration regulator that adjusts at least one of the intensity and vibration frequency of vibration applied by the vibration application unit according to the weight being measured.

The aforementioned dust collecting apparatus may further include a dust remover being installed below the dust outlet and removing dust from the dust outlet at a set frequency.

To achieve the aforementioned object, according to one aspect of the present invention, in a control method of a dust collecting apparatus using a filter bag, installed with an internal partition vertically downward from an upper surface of a housing to separate the upper interior of the housing into two sides, and installed with a plurality of filter bags on one side of the upper interior of the housing with reference to the internal partition, the control method of a dust collecting apparatus is characterized by comprising the steps of: injecting contaminated gas into the side surface of the upper end opposite the side where the filter bags are installed, such that inertial collision occurs through the internal partition; filtering the contaminated gas flowing over the lower end of the internal partition by each of the filter bags; and discharging the gas filtered by each of the filter bags.

The control method of the aforementioned dust collecting apparatus may further include a step of spraying air toward each of the filter bags at the lower end of the housing.

The control method of the aforementioned dust collecting apparatus may further include the steps of: measuring humidity for contaminated gas at the lower end of the internal partition; and adjusting at least one of a temperature and a spraying force for the air being sprayed according to the measured humidity.

The control method of the aforementioned dust collecting apparatus may further include a step of applying vibration to a funnel-shaped inclined surface of the lower end of the housing.

The control method of the aforementioned dust collecting apparatus may further include the steps of: measuring the weight being applied to a funnel-shaped inclined surface of the housing; and adjusting at least one of the intensity and vibration frequency of the applied vibration according to the weight being measured.

The control method of the aforementioned dust collecting apparatus may further include a step of scraping and removing dust from a dust outlet of the housing at a set frequency.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### Advantageous Effects

According to the present invention, even when contaminated air contains moisture or oil, firstly, the filtration efficiency of the filter bag is improved by removing dust using inertial collision, and secondly, the performance of the dust removal dust collecting apparatus is greatly enhanced by filtering the dust through the filter bag and smoothly discharging the dust such as filtered fine particles or dirt through an outlet.

### BRIEF DESCRIPTION OF DRAWINGS

Preferred exemplary embodiments of the invention are illustrated in the accompanying drawings in which like reference numerals represent like parts throughout, and in which:

FIG. 1 is a schematic drawing of a dust removal filter bag dust collecting apparatus according to a first embodiment of the present invention.

FIG. 2 is a cross-sectional view illustrating the interior of a dust collecting apparatus illustrated in FIG. 1.

FIG. 3 is a schematic drawing of a dust removal filter bag dust collecting apparatus according to a second embodiment of the present invention.

FIG. 4 is a cross-sectional view illustrating the interior of a dust collecting apparatus illustrated in FIG. 3.

FIG. 5 is a drawing illustrating an internal partition illustrated in FIG. 4.

FIG. 6 is a schematic drawing illustrating a configuration for preventing dust accumulation on an inclined surface of a housing of a dust collecting apparatus illustrated in FIG. 3.

FIG. 7 is a schematic drawing illustrating a configuration for drying contaminated gas in a dust collecting apparatus illustrated in FIG. 3.

FIG. 8 is a flowchart illustrating a control method for a dust removal filter bag dust collecting apparatus according to an embodiment of the present invention.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DETAILED DESCRIPTION OF BEST MODE

Hereinafter, some embodiments of the present invention will be described with reference to exemplary drawings. When designating components in each drawing, identical components will be designated with the same reference numerals, wherever possible, even if they appear in different drawings. Furthermore, in describing embodiments of the present invention, detailed descriptions of related known structures or functions will be omitted if they are deemed to hinder understanding of the embodiments of the present invention.

In addition, in describing the components of the embodiment of the present invention, terms such as first, second, A, B, (a), and (b) may be used. These terms are merely intended to distinguish the components from other components, and the terms do not limit the nature, order or sequence of the components. When a component is described as being 'connected', 'coupled' or 'interconnected' to another component, the component may directly connected, coupled or interconnected to the other component, but it should be understood that another component may also be 'connected', 'coupled', or 'interconnected' between that component and that other components.

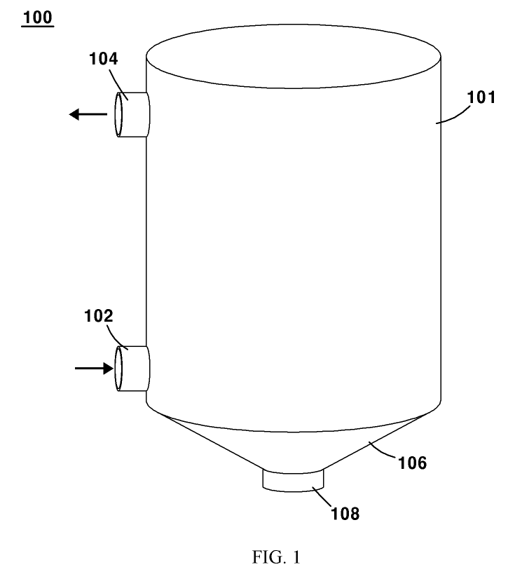

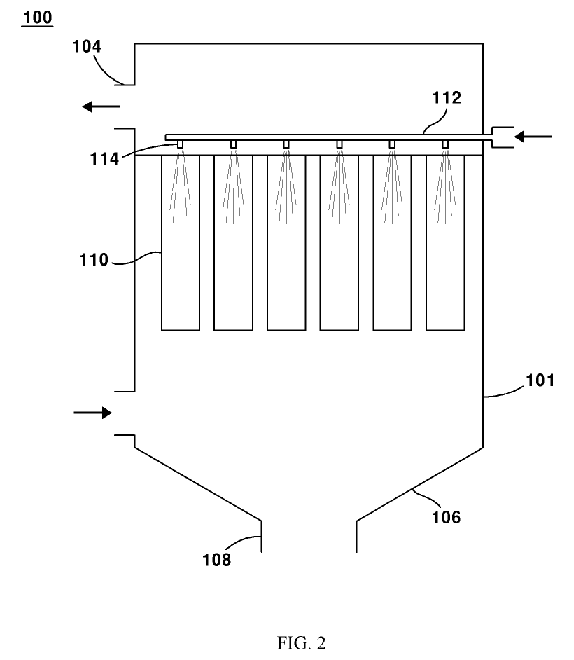

FIG. 1 is a schematic drawing of a dust removal filter bag dust collecting apparatus according to a first embodiment of the present invention; and FIG. 2 is a cross-sectional view illustrating the interior of a dust collecting apparatus illustrated in FIG. 1.

Referring to FIGS. 1 and 2, a dust collecting apparatus 100 according to a first embodiment of the present invention comprises a housing 101, a contaminated gas inlet 102, a gas outlet 104, a lower housing 106, a dust outlet 108, a filter bag 110, a compressed gas supply pipe 112, and a spray nozzle 114.

The housing 101 is formed in a cylindrical shape, and a lower housing 106 being formed in a funnel shape and a dust outlet 108 for discharging dust are formed at a lower portion thereof.

In addition, the housing 101 has a contaminated gas inlet 102 formed at the lower end of the cylindrical shape into which contaminated gas is injected, and a gas outlet 104 formed at the upper end of the cylindrical shape into which clean air filtered of dust such as fine particles or dirt is discharged by a filter bag 110.

The filter bag 110 is positioned at a height between the contaminated gas inlet 102 and the gas outlet 104 inside the housing 101. In this case, dust such as fine particles or dirt in the contaminated air injected through the contaminated gas inlet 102 is filtered by the filter bag 110 and attached to the outer surface of the filter bag 110, and only clean gas passes through the filter bag 110 and is discharged to the gas outlet 104.

A compressed gas supply pipe 112 periodically supplies high-pressure compressed gas to the interior of the housing 101, and sprays the compressed gas in the opposite direction to the filter bag 110 through a spray nozzle 114 corresponding to each filter bag 110. Through this, dust attached to the outer surface of each filter bag 110 is separated from the filter bag 110 and falls downward.

In this case, the lower housing 106 has a funnel shape, and since a dust outlet 108 is formed at the center thereof, the heavy dust in the contaminated air and the dust separated from each filter bag 110 slide along the inclined surface of the lower housing 106 and are discharged to the outside through the dust outlet 108.

However, in the case of a dust collecting apparatus having such a structure, if the contaminated gas contains moisture or oil, dust attached to the outer surface of the filter bag 110 may remain without being separated from the filter bag 110 even if compressed gas is sprayed in the opposite direction through the spray nozzle 114. In this way, dust remaining on the outer surface of the filter bag 110 becomes one of the main causes of reducing the filtration efficiency of the filter bag 110.

In addition, since dust falling downward in the contaminated air may contain moisture or oil, it may not slide down the slope of the lower housing 106 and may remain there. The dust remaining on the slope in this way may hinder the discharge of other dust, thereby lowering the discharge performance of the dust collecting apparatus.

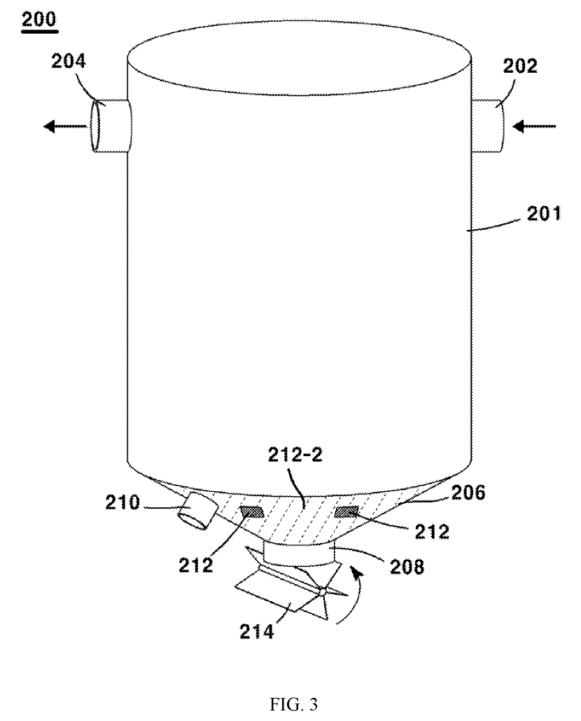

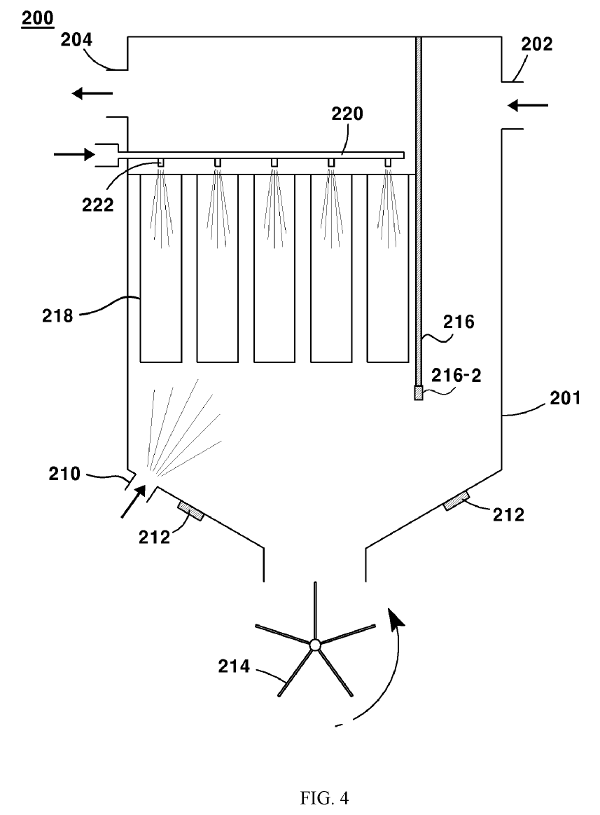

FIG. 3 is a schematic drawing of a dust removal filter bag dust collecting apparatus according to a second embodiment of the present invention; and FIG. 4 is a cross-sectional view illustrating the interior of a dust collecting apparatus illustrated in FIG. 3.

Referring to FIGS. 3 and 4, a dust collecting apparatus 200 according to a second embodiment of the present invention may comprise a housing 201, a contaminated gas inlet 202, a gas outlet 204, a lower housing 206, a dust outlet 208, an air injector 210, a vibration application unit 212, a weight measurement sensor 212-2, a vibration regulator 212-4, a dust remover 214, an internal partition 216, a humidity measurement sensor 216-2, an air regulator 216-4, a filter bag 218, a compressed gas supply pipe 220, and a spray nozzle 222.

The housing 201 is formed in a cylindrical shape, and a lower housing 206 formed in a funnel shape and a dust outlet 208 for discharging dust are formed at the center of the lower housing 206.

The contaminated gas inlet 202 is formed on the side surface of the upper end of the cylindrical housing 201 and injects contaminated gas into the upper end of the interior of the housing 201. That is, the dust collecting apparatus according to an embodiment of the present invention is different from the dust collecting apparatus according to a first embodiment in which the contaminated gas inlet 102 injects contaminated gas into the lower end of the interior of the housing 101 in that the contaminated gas inlet 202 is formed at the upper end of the cylindrical housing 201 and injects contaminated gas into the upper end of the interior of the housing 201. At this time, the contaminated gas inlet 202 may forcibly inject contaminated gas into the interior of the housing 201 using a fan (not shown).

The gas outlet 204 is formed at the upper end of the cylindrical shape on the side opposite to the contaminated gas inlet 202, and discharges clean air filtered of fine particles or dirt, and the like, by the filter bag 218. At this time, the gas outlet 204 may also forcibly discharge gas from the inside of the housing 201 using a fan (not shown).

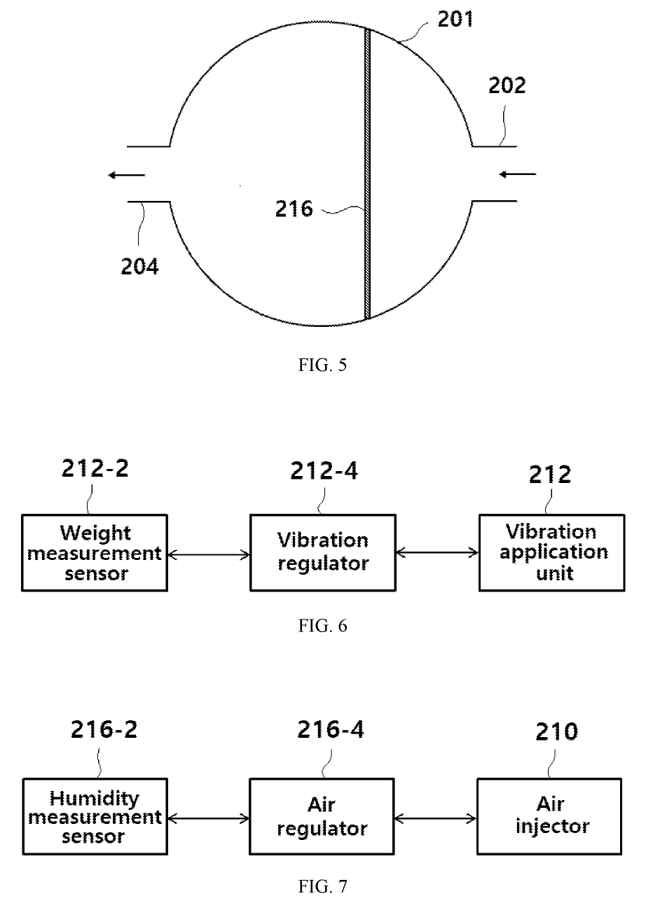

At this time, an internal partition 216 is installed between the contaminated gas inlet 202 and the gas outlet 204 of the housing 201 to divide the inside of the upper end of the housing 201 into two sides vertically downward from the upper surface of the housing 201. In this case, it is preferable that the internal partition 216 be shorter than the length of the cylinder of the housing 201. That is, the contaminated gas injected into the upper portion of the interior of the housing 201 through the contaminated gas inlet 202 can flow to the opposite side of the internal partition 216 through the lower end of the internal partition 216. At this time, the internal partition 216, as illustrated in FIG. 5, separates the upper end of the interior of the housing 201 and blocks the contaminated gas injected through the contaminated gas inlet 202 installed on the side surface of the upper end of the housing 201 from directly flowing toward the gas outlet 204. In this case, the contaminated gas injected into the side surface of the upper end of the housing 201 primarily hits the internal partition 216 to cause an inertial collision, and accordingly, dust containing large dust, heavy dust, moisture or oil components, and the like among the contaminated gas do not directly affect the filter bag 218 and fall downward.

The filter bag 218 is installed between the gas outlet 204 of the housing 201 and the internal partition 216. At this time, it is preferable that the length of the internal partition 216 be set so that its upper end is lower than the gas outlet 204 and its lower end is higher than the lower end of the internal partition 216.

At this time, the filter bag 218 secondarily filters the contaminated gas passing through the lower end of the internal partition 216. At this time, dust included in the contaminated gas, such as dust that is relatively large or heavy, dust containing moisture or oil, and the like, is primarily removed by the internal partition 216, so the filter bag 218 can filter the dust with improved filtration efficiency compared to the dust removal filter bag dust collecting apparatus 100 according to a first embodiment, and discharge the clean gas through the gas outlet 204.

The air injector 210 can be installed in the lower end of the cylindrical housing 201 or the funnel-shaped lower housing 206. At this time, the air injector 210 injects air toward the filter bag 218 for the contaminated gas passing over the lower end of the internal partition 216. In this case, the air injector 210 can dry the contaminated gas and raise it toward the filter bag 218 even if the contaminated gas contains moisture or oil by injecting air heated to a set temperature and intensity or higher.

The compressed gas supply pipe 220 periodically supplies high-pressure compressed gas to the interior of the housing 201, and sprays the compressed gas in the opposite direction to the filter bag 218 through the spray nozzle 222 corresponding to each filter bag 218. At this time, it is preferable that the compressed gas supply pipe 220 sprays the compressed gas by crossing the air injection by the air injector 210.

In this way, as the air injector 210 injects air with a set temperature and injection strength into the inner lower end of the housing 201, the contaminated gas rises from the lower end of the housing 201 toward the filter bag 218, and the air filtered by the filter bag 218 is discharged through the gas outlet 204.

In addition, even if the contaminated gas injected through the contaminated gas inlet 202 contains moisture or oil, the contaminated gas is dried by the air injected by the air injector 210, and therefore, when the compressed gas supply pipe 220 injects the compressed gas in the opposite direction through the spray nozzle 222, the dust attached to the outer surface of the filter bag 218 can be easily separated from the filter bag 218 and fall downward by being filtered by the filter bag 218.

The lower housing 206 has a funnel shape, and a dust outlet 208 is formed in the center thereof. Accordingly, dust with a heavy mass in the contaminated air and dust separated from the filter bag 218 slide along the inclined surface of the lower housing 206 and are discharged to the outside through the dust outlet 208.

The vibration application unit 212 is installed on the funnel-shaped inclined surface of the housing 201, that is, the outer surface of the lower housing 206, and applies vibration to the lower housing 206. At this time, the vibration application unit 212 can be implemented with a plurality of motors, and each of them can be installed on the outer surface of the lower housing 206 at a set interval to apply vibration.

The weight measurement sensor 212-2 is installed on the outer surface of the lower housing 206 and measures the weight applied to the funnel-shaped inclined surface of the lower housing 206. At this time, the weight measurement sensor 212-2 is installed in multiple numbers on the outer surface of the lower housing 206 at set intervals, and each can measure the weight applied to a corresponding area.

The vibration regulator 212-4 can be electrically connected to the weight measurement sensor 212-2 and the vibration application unit 212, as illustrated in FIG. 6. At this time, the vibration regulator 212-4 adjusts at least one of the intensity and the frequency of the vibration applied by the vibration application unit 212 according to the weight measured by the weight measurement sensor 212-2.

When the weight measurement sensor 212-2 measures the weight at various locations of the lower housing 206, the vibration regulator 212-4 calculates an average value of each measured weight, and can uniformly adjust the intensity and frequency of vibration applied by the vibration application unit 212 based on the calculated average value. At this time, the vibration regulator 212-4 classifies the weight into various stages, matches and stores the intensity and frequency values of vibration corresponding to each classified stage, and can uniformly adjust the intensity and frequency of vibration of each vibration application unit 212 depending on which stage the calculated average value of the weight corresponds to.

In addition, when the weight measurement sensor 212-2 measures the weight at various locations of the lower housing 206, the vibration regulator 212-4 matches and stores the identification information corresponding to each weight measurement sensor 212-2 and the identification information of the vibration application unit 212 at the corresponding location, and can independently control the corresponding vibration application unit 212 according to the weight measured by each weight measurement sensor 212-2. At this time, the vibration regulator 212-4 classifies the weight into various stages, matches and stores the values of the intensity and frequency of the vibration corresponding to each classified stage, and can independently control the intensity and frequency of the vibration of each vibration application unit 212 according to which stage the weight measured by each weight measurement sensor 212 corresponds.

Through this, the dust collecting apparatus according to the embodiment of the present invention can relieve dust accumulation by applying an optimal vibration intensity and frequency according to the degree of dust accumulated when dust is accumulated in the lower housing.

In addition, the dust collecting apparatus according to an embodiment of the present invention may prevent unnecessary waste of power by applying vibration only to the relevant area to relieve the load of dust when dust above the set weight is accumulated in a specific area of lower housing.

The dust remover 214 is installed below the dust outlet 208 and scrapes and removes dust from the dust outlet 208 at a set frequency. At this time, the dust remover 214 can scrape and remove dust being discharged from the dust outlet 208 while a plurality of blades rotates sequentially.

Through this, the dust collecting apparatus according to an embodiment of the present invention can prevent the phenomenon in which dust that forms a clump blocks a dust outlet and causes further dust accumulation by scraping and removing the dust even if the dust combines with one another to form a clump.

The humidity measurement sensor 216-2 can be installed at the lower end of the internal partition 216, and can measure the humidity of the contaminated gas injected through the contaminated gas inlet 202 when the contaminated gas passes over the lower end of the internal partition 216. At this time, it is preferable that the humidity measurement sensor 216-2 is installed over the entire lower surface of the internal partition 216.

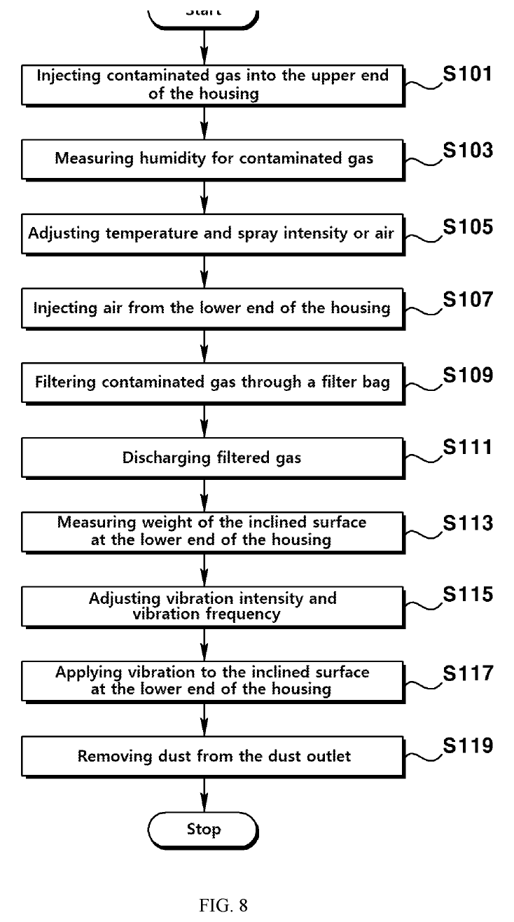

The air regulator 216-4 can be electrically connected to the humidity measurement sensor 216-2 and the air injector 210, as illustrated in FIG. 7. At this time, the air regulator 216-4 controls at least one of the temperature and the spray intensity of the air supplied by the air injector 210 according to the humidity being measured by the humidity measurement sensor 216-2. Here, the air regulator 216-4 classifies humidity into multiple stages, matches and stores the temperature and injection strength of the air in response to each stage, and adjusts the air injector 210 with the temperature and injection strength of the air corresponding to the corresponding stage according to which stage the humidity measured by the humidity measurement sensor 216-2 corresponds to.

According to the present invention, the filtration efficiency of a filter bag can be improved based on various IoT (Internet of Things) such as inertial collision, weight measurement sensor, and humidity measurement sensor.

FIG. 8 is a flowchart illustrating a control method for a dust removal filter bag dust collecting apparatus according to an embodiment of the present invention. The control method of the dust collecting apparatus according to an embodiment of the present invention can be performed by the dust collecting apparatus 200 shown in FIGS. 3 to 7.

The housing 201 is formed in a cylindrical shape, and a lower housing 206 formed in a funnel shape and a dust outlet 208 for discharging dust are formed at the center of the lower housing 206.

The dust collecting apparatus 200 injects contaminated gas into the upper end of the interior of a cylindrical housing 201 through a contaminated gas inlet 202 (S101). At this time, the dust collecting apparatus 200 may also forcibly inject contaminated gas into the upper end of the interior of the housing 201 using a fan.

Between the contaminated gas inlet 202 and the gas outlet 204 of the housing 201, an internal partition 216 is installed to divide the upper interior of the housing 201 into two sides from the upper surface of the housing 201 toward the vertically downward direction. In this case, the internal partition 216 is implemented to be shorter than the length of the cylinder of the housing 201. That is, the contaminated gas being injected into the upper end of the interior of the housing 201 through the contaminated gas inlet 202 may flow to the opposite side of the internal partition 216 through the lower end of the internal partition 216. At this time, the internal partition 216 blocks the contaminated gas injected into the upper end of the interior of the housing 201 through the contaminated gas inlet 202 from directly flowing toward the gas outlet 204.

A humidity measurement sensor 216-2 is installed over the entire lower surface of the internal partition 216, and the dust collecting apparatus 200 measures the humidity of contaminated gas passing over the lower end of the internal partition 216 using the humidity measurement sensor 216-2 (S103).

An air regulator 216-4 may be electrically connected between the humidity measurement sensor 216-2 and the air injector 210. At this time, the dust collecting apparatus 200 uses the air regulator 216-4 to control at least one of the temperature and the spray intensity of the air being applied by the air injector 210 according to the humidity being measured by the humidity measurement sensor 216-2 (S105). Here, the dust collecting apparatus 200 classifies the humidity into a plurality of stages, matches and stores the temperature and the spray intensity of the air corresponding to each stage, and sets the air injector 210 to the temperature and the spray intensity of the air corresponding to the stage according to which stage the humidity measured by the humidity measurement sensor 216-2 corresponds.

The air injector 210 can be installed in the lower end of the cylindrical housing 201 or the funnel-shaped lower housing 206. At this time, the dust collecting apparatus 200 uses the air injector 210 to inject air toward the filter bag 218 toward the contaminated gas passing over the lower end of the internal partition 216 (S107). In this case, the dust collecting apparatus 200 can dry the contaminated gas and raise it toward the filter bag 218 even if the contaminated gas contains moisture or oil by injecting air heated to a temperature and intensity higher than the set temperature.

The filter bag 218 is installed between the gas outlet 204 of the housing 201 and the internal partition 216. At this time, it is preferable that the length of the internal partition 216 is set so that its upper end is lower than the gas outlet 204 and its lower end is higher than the lower end of the internal partition 216.

The dust collecting apparatus 200 filters the contaminated gas passing through the lower end of the internal partition 216 using the filter bag 218 (S109). At this time, the dust contained in the contaminated gas is filtered by the filter bag 218, and the dust collecting apparatus 200 discharges the clean gas passing through the filter bag 218 through the gas outlet 204 (S111).

Here, since the gas outlet 204 is formed at the upper end of the cylindrical shape on the side opposite to the contaminated gas inlet 202, clean air filtered of dust such as fine particles or dirt by the filter bag 218 can be discharged. In addition, the dust collecting apparatus 200 can forcibly discharge gas passing through the filter bag 218 by installing a fan in the gas outlet 204.

The compressed gas supply pipe 220 periodically supplies high-pressure compressed gas to the inside of the housing 201, and sprays the compressed gas in the opposite direction to the filter bag 218 through the spray nozzle 222 corresponding to each filter bag 218. At this time, it is preferable that the compressed gas supply pipe 220 sprays the compressed gas by intersecting the air injection by the air injector 210. In addition, when the gas discharge through the gas outlet 204 is forcibly performed, the compressed gas supply pipe 220 may also spray the compressed gas by intersecting the gas discharge through the gas outlet 204.

In this way, as the air injector 210 injects air with a set temperature and injection strength into the inner lower end of the housing 201, the contaminated gas rises from the lower end of the housing 201 toward the filter bag 218, and the air filtered by the filter bag 218 is discharged through the gas outlet 204.

In addition, even if the contaminated gas injected through the contaminated gas inlet 202 contains moisture or oil, the contaminated gas is dried by the air injected by the air injector 210, and therefore, when the compressed gas supply pipe 220 injects the compressed gas in the opposite direction through the spray nozzle 222, the dust attached to the outer surface of the filter bag 218 can be easily separated from the filter bag 218 and fall downward by being filtered by the filter bag 218.

The lower housing 206 has a funnel shape, and a dust outlet 208 is formed in the center thereof. Accordingly, dust with a heavy mass in the contaminated air and dust separated from the filter bag 218 slide along the inclined surface of the lower housing 206 and are discharged to the outside through the dust outlet 208.

The weight measurement sensor 212-2 is installed on the outer surface of the lower housing 206. At this time, the dust collecting apparatus 200 measures the weight being applied to the funnel-shaped inclined surface of the lower housing 206 using the weight measurement sensor 212-2 (S113). Here, the weight measurement sensor 212-2 is installed in multiple numbers on the outer surface of the lower housing 206 at set intervals, and each can measure the weight being applied to a corresponding area.

The vibration regulator 212-4 can be electrically connected to the weight measurement sensor 212-2 and the vibration application unit 212. At this time, the dust collecting apparatus 200 uses the vibration regulator 212-4 to control at least one of the intensity and the vibration frequency applied by the vibration application unit 212 according to the weight being measured by the weight measurement sensor 212-2 (S115).

Here, when the weight measurement sensor 212-2 measures the weight at various locations of the lower housing 206, the dust collecting apparatus 200 calculates an average value of each weight being measured, and can uniformly adjust the intensity and frequency of vibration applied by the vibration application unit 212 based on the calculated average value. At this time, the dust collecting apparatus 200 classifies the weight into various stages, matches and stores the intensity and frequency values of vibration corresponding to each classified stage, and can uniformly adjust the intensity and frequency of vibration of each vibration application unit 212 depending on which stage the calculated average value of the weight corresponds to.

In addition, when the weight measurement sensor 212-2 measures the weight at various locations of the lower housing 206, the dust collecting apparatus 200 matches and stores the identification information corresponding to each weight measurement sensor 212-2 and the identification information of the vibration application unit 212 at the corresponding location, and can independently control the corresponding vibration application unit 212 according to the weight measured by each weight measurement sensor 212-2. At this time, the dust collecting apparatus 200 classifies the weight into various stages, matches and stores the values of the intensity and frequency of the vibration corresponding to each classified stage, and can independently control the intensity and frequency of the vibration of each vibration application unit 212 according to which stage the weight measured by each weight measurement sensor 212 corresponds.

The dust collecting apparatus 200 applies vibration to the lower housing 206 through a vibration application unit 212 installed on the funnel-shaped inclined surface of the housing 201, that is, the outer surface of the lower housing 206 (S117). At this time, the vibration application unit 212 is composed of a plurality of motors, and each can be installed on the outer surface of the lower housing 206 at a set interval.

Through this, the dust collecting apparatus according to an embodiment of the present invention can relieve dust accumulation by applying an optimal vibration intensity and frequency according to the degree of dust accumulated when dust is accumulated in the lower housing.

In addition, the dust collecting apparatus according to the embodiment of the present invention can prevent unnecessary waste of power by applying vibration only to a specific area of the lower housing to relieve dust accumulation when dust exceeding a set weight is loaded in that area.

The dust collecting apparatus 200 uses a dust remover 214 installed below the dust outlet 208 to scrape and remove dust from the dust outlet 208 at a set frequency (S119). At this time, the dust remover 214 can scrape and remove dust discharged from the dust outlet 208 while a plurality of blades rotates sequentially.

Through this, the dust collecting apparatus according to an embodiment of the present invention can prevent the phenomenon in which dust that forms a clump blocks a dust outlet and causes further dust accumulation by scraping and removing the dust even if the dust combines with one another to form a clump.

Although embodiments according to the present invention have been described above, these are merely exemplary. Those with ordinary skill in the art will understand that various modifications and embodiments within an equivalent range are possible. Therefore, the scope of protection of the present invention should be defined not only by the following claims but also by their equivalents. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

We claim:

1. A pre-treatment dust removal filter bag dust collecting apparatus using inertial collision characterized by comprising:
a housing having a funnel-shaped dust outlet formed at a cylindrical lower end;
an internal partition installed vertically downward from an upper surface of the housing to divide the inner upper portion of the housing into two sides;
a plurality of filter bags being installed at one side of the inner upper portion of the housing with reference to the internal partition;
a contaminated gas inlet for injecting a contaminated gas into the upper portion of the other side of the housing with reference to the internal partition; and
a gas outlet being installed at the upper portion of the plurality of filter bags and discharging a gas filtered by each of the filter bags, wherein the internal partition primarily performs inertial collision on the contaminated gas being injected, and
wherein each of the filter bags secondarily performs filtering on the contaminated gas passing through the lower end of the internal partition.

2. The pre-treatment dust removal filter bag dust collecting apparatus using inertial collision of claim 1, further comprising:
an air injector that injects air toward each of the filter bags at the lower end of the housing.

3. The pre-treatment dust removal filter bag dust collecting apparatus using inertial collision of claim 2, further comprising:
a humidity measurement sensor that measures humidity of contaminated gas at the lower end of the internal partition; and
an air regulator for controlling at least one of the temperature and injection strength of air injected through the air injector according to the measured humidity.

4. The pre-treatment dust removal filter bag dust collecting apparatus using inertial collision of claim 1, further comprising:
a vibration application unit that applies vibration to a funnel-shaped inclined surface of the housing.

5. The pre-treatment dust removal filter bag dust collecting apparatus using inertial collision of claim 4, further comprising:
a weight measurement sensor that measures a weight applied to a funnel-shaped inclined surface of the housing; and
a vibration regulator that adjusts at least one of the intensity and vibration frequency of vibration applied by the vibration application unit according to the weight being measured.

6. The pre-treatment dust removal filter bag dust collecting apparatus using inertial collision of claim 1, further comprising:
a dust remover being installed below the dust outlet and removing dust from the dust outlet at a set frequency.

7. A method of controlling a dust collecting apparatus, installed with an internal partition vertically downward from an upper surface of a housing to separate the upper interior of the housing into two sides, and installed with a plurality of filter bags on one side of the upper interior of the housing with reference to the internal partition, comprising the steps of:
injecting contaminated gas into the side surface of the upper end opposite the side where the filter bags are installed, such that inertial collision occurs through the internal partition;
filtering the contaminated gas flowing over the lower end of the internal partition by each of the filter bags; and
discharging the gas filtered by each of the filter bags.

8. The method of claim 7 further comprising the step of spraying air toward each of the filter bags at the lower end of the housing.

9. The method of claim 8 further comprising the steps of:
measuring humidity for contaminated gas at the lower end of the internal partition; and
adjusting at least one of a temperature and a spraying force for the air being sprayed according to the measured humidity.

10. The method of claim 7 further comprising the step of:
applying vibration to a funnel-shaped inclined surface of the lower end of the housing.

11. The method of claim 10 further comprising the steps of:
measuring the weight being applied to a funnel-shaped inclined surface of the housing; and
adjusting at least one of the intensity and vibration frequency of the applied vibration according to the weight being measured.

12. The method of claim 7 further comprising the step of scraping and removing dust from a dust outlet of the housing at a set frequency.
